(19) United States
(12) Patent Application Publication
(10) Pub. No.: US 2017/0028902 A1
(43) Pub. Date: Feb. 2, 2017

(54) SAFE BACKUP SYSTEM FOR VEHICLES

(71) Applicant: ElevationTV LLC, New York, NY (US)

(72) Inventor: Eric Diaz, Peabody, MA (US)

(21) Appl. No.: 15/202,886

(22) Filed: Jul. 6, 2016

Related U.S. Application Data
(60) Provisional application No. 62/199,086, filed on Jul. 30, 2015.

(51) Int. Cl. B60Q 1/00

(52) U.S. Cl. CPC B60Q 1/0035; B60Q 2400/50

(57) ABSTRACT

A vehicle safety device and system are disclosed. The device comprises an image projecting device and a vehicle communication device adapted to receive commands for the image projecting device. The image projecting device is adapted to project visible safety information.

### REFERENCE TO RELATED APPLICATIONS

This application claims priority to U.S. Provisional Application No. 62/199,086 filed Jul. 30, 2015 and entitled “Safe Backup System for Vehicles”, the entirety of which is specifically incorporated by reference.

### BACKGROUND

1. Field of the Invention

This invention is related to vehicular safety features. In particular, this invention is directed to lighting systems in vehicles designed to indicate directionality to third-party drivers and observers.

2. Background of the Invention

In the field of vehicular safety, most vehicles contain a mechanism for indicating they are reversing their car, usually in the form of a white light linked to their taillights. Some vehicles also make a noise to indicate reversing. The current convention on reversing safety is a camera or several cameras attached to a vehicle that provide a 3-dimensional snapshot or video of the environment surrounding the vehicle. The driver can view this image or video via a viewer mounted or otherwise installed in the vehicle, and can therefore reverse in a more efficient and safer manner. This camera alleviates blind spots for the driver, and helps the driver minimize rearward collisions.

According to the U.S. National Highway Traffic Safety Administration, back up collisions caused 34% of U.S. non-traffic fatalities of children under the age of 15 from the years 2006-2010. From 2001-2003, approximately 7,475 children under the age of 15 were treated for automobile back-over incidents. About 300 fatalities per year result from backup collisions.

Backup cameras aid drivers in avoiding these collisions, but they do not alert third-party drivers of the driver's intended direction. Tail lights are not an adequate alert, as they are only viewed by the third-party driver or pedestrian within 10-20 feet of the oncoming vehicle, and they do not project light around potentially view-blocking obstacles, such as parked cars and trees. Furthermore, these white lights are difficult to see during the daytime, and are therefore less effective at preventing collision from the perspective of other drivers.

Backup sensors, which alert a driver to their vehicle's position in relation to surrounding objects, are also effective in the prevention of backup accidents. However, they also have the setback of only alerting an individual to the position of their own car, without giving other drivers, pedestrians and others in the vicinity of the vehicle an alert of the car's position.

Therefore, there is a need for a system that alerts third party drivers and pedestrians to the movement of a car.

### SUMMARY OF THE INVENTION

The present invention overcomes the problems and disadvantages associated with current strategies and designs and provides new systems and devices for alerting third-parties to a vehicles movements.

One embodiment of the invention is directed to a vehicle safety device. The device comprises an image projecting device and a vehicle communication device adapted to receive commands for the image projecting device. The image projecting device is adapted to project visible safety information.

In a preferred embodiment, the image projecting device is an LED. The vehicle safety device preferably further comprises a computer coupled to the image projecting device, wherein the computer stores a plurality of projectable images and directs which of the plurality of projectable images the image projecting device is to project. The projectable images are preferably at least one of words, icons, graphics, pictures, symbols, and combinations thereof. A choice of the plurality of projectable images is preferably obtained through the vehicle communication device.

Preferably, the vehicle communication device is adapted to communicate with a vehicle's onboard computer, a portable personal communication device, or to receive signals from mechanical changes in the vehicle. Preferably, the vehicle safety device alerts people in the vicinity of a vehicle that the vehicle is in reverse. The vehicle safety device is preferably adapted to be mounted on a rear bumper of a vehicle. In a preferred embodiment, the vehicle safety device is adapted to projects the visible information onto a ground surface behind a vehicle. Preferably, the vehicle safety device is adapted to be coupled to the vehicle's reverse indicators and activates when the reverse indicators activate. Preferably, the projected visible information is surrounded by a beam of light. In a preferred embodiment, the beam of light projects at least 45° vertically and 90° horizontally from the image projecting device. Preferably, the device is controlled by a remote computer application.

Another embodiment of the invention is directed to a vehicle safety system. The system comprises an image projecting device, a mount coupling the image projecting device to a vehicle, and a vehicle communication device adapted to facilitate communication between the image projecting device and the vehicle. The image projecting device is adapted to project visible information from the vehicle.

In a preferred embodiment, the image projecting device is an LED. Preferably, the system further comprises a computer coupled to the image projecting device, wherein the computer stores a plurality of projectable images and directs which of the plurality of projectable images the image projecting device is to project. Preferably, the projectable images are at least one of words, icons, graphics, pictures, symbols, and combinations thereof. Preferably, a choice of the plurality of projectable images is obtained through the vehicle communication device.

The vehicle communication device is preferably adapted to communicate with the vehicle's onboard computer, a portable personal communication device, or to receive signals from mechanical changes in the vehicle. Preferably, the vehicle safety device alerts people in the vicinity of the vehicle that the vehicle is in reverse. Preferably, the vehicle safety device is mounted on a rear bumper of the vehicle. In a preferred embodiment, the vehicle safety device projects the visible information onto a ground surface behind the vehicle. The vehicle safety device is preferably coupled to the vehicle's reverse indicators and activates when the reverse indicators activate. Preferably, the visible information is surrounded by a beam of light. Preferably, the beam of light projects at least 45° vertically and 90° horizontally from the image projecting device. Preferably, the image projecting device is controlled by a remote computer application.

Other embodiments and advantages of the invention are set forth in part in the description, which follows, and in part, may be obvious from this description, or may be learned from the practice of the invention.

### DESCRIPTION OF THE DRAWING

The invention is described in greater detail by way of example only and with reference to the attached drawing, in which:

FIG. 1A depicts a birds-eye view of a vehicle with the device attached to the rear.

FIG. 1B depicts a perspective view of a vehicle with the device attached to the rear.

FIG. 2 depicts a schematic of an embodiment of the invention.

### DESCRIPTION OF THE INVENTION

As embodied and broadly described herein, the disclosures herein provide detailed embodiments of the invention. However, the disclosed embodiments are merely exemplary of the invention that may be embodied in various and alternative forms. Therefore, there is no intent that specific structural and functional details should be limiting, but rather the intention is that they provide a basis for the claims and as a representative basis for teaching one skilled in the art to variously employ the present invention

A problem in the art capable of being solved by the embodiments of the present invention is preventing vehicle backing-up accidents. It has been surprisingly discovered that back-up safety equipment such as sensors and video cameras do not wholly prevent back-up accidents. It has also been surprisingly discovered that no device exists to visually alert third-party drivers, pedestrians, bicyclists and others in the vicinity of the vehicle to the intended reversal.

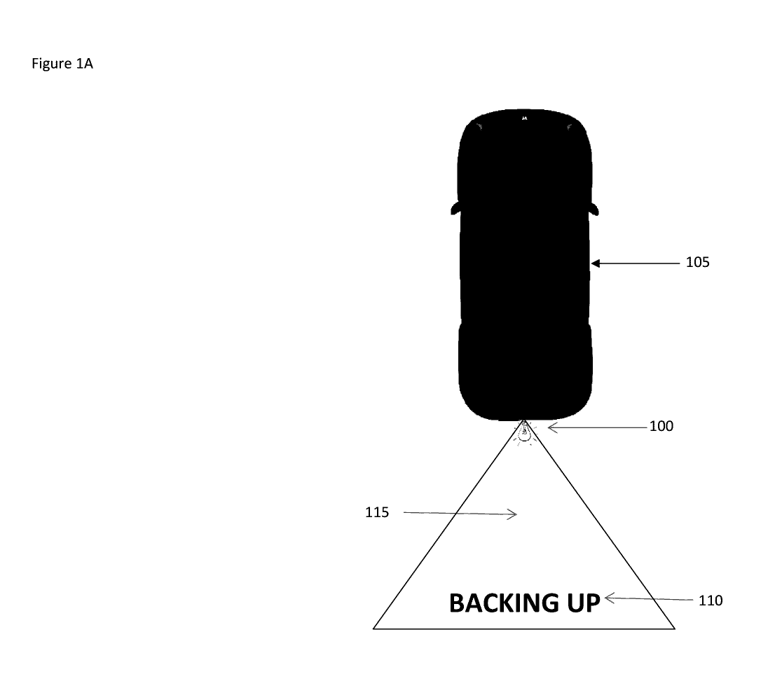

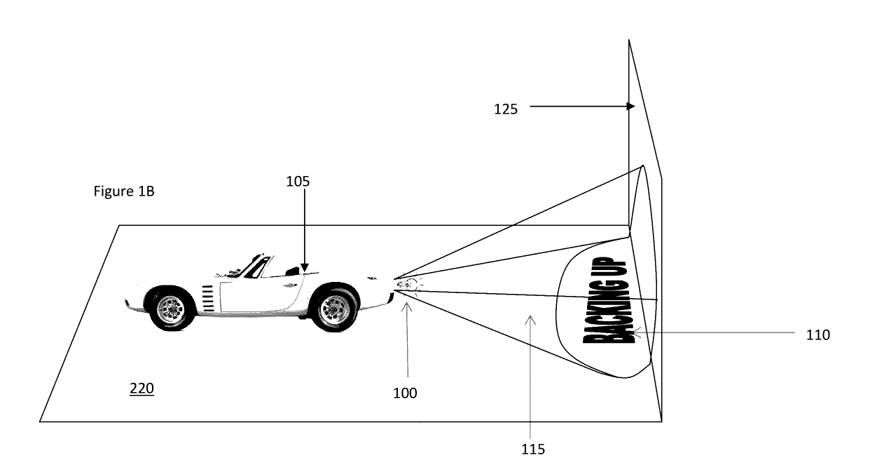

The present invention overcomes the problems and disadvantages associated with current strategies and designs for reversing-safety equipment in vehicles. FIGS. 1A-B depict an embodiment of the present invention. Device 100 can be attached to a vehicle 105 to provide a visual alert system to drivers, pedestrians and other people in the vicinity of vehicle 105. Vehicle 105 can be a car, truck, motorcycle, bicycle, plane, helicopter, boat, ATV, RV, bus, train, trolley, or another transportation device. The device 100 projects a visual cue 115, which can be a in the form of a projected display 110 that can be projected behind the vehicle onto a medium such as the pavement, road, sidewalk, driveway or other path a vehicle is reversing into. The projected display 110 can also be projected at an angle so that the space or any objects behind the vehicle are illuminated, and the word can also be projected onto said space or objects. In the preferred embodiment, device 100 projects visual cue 115 at a 90° arc, a 135° arc, or a 180° arc behind vehicle 105. The light and the words are preferably large and bright enough for someone with average visual acuity and even impaired visual acuity to detect. This light and/or lettering can preferably be seen or read from a distance of 10 feet, 30 feet, 50 feet, or 100 feet.

FIG. 1B displays an example of a perspective view of device 100 projecting visual cue 115 and projected display 110. Preferably, device 100 projects vertically simultaneously as horizontally, thereby projecting a cone of visual cue 115. The cone of projection may be angled toward the ground 120 or perpendicularly to the ground 120. Preferably, the cone of projection is adjusted to optimize the readability of the projected display 110. While the visual cue 115 is preferably projected in a cone shape, the projected display 110 is preferably directed toward the ground 120 within the visual cue 115 such that visual cue 115 illuminates both the ground 120 and an area behind vehicle 105 (e.g. the wall 125 as shown in FIG. 1B). Device 100 may be positioned such that projected display 110 appears at a specified distance behind vehicle 105. For example, projected display may appear 1 foot behind vehicle 105, 5 feet behind vehicle 105, 10 feet behind vehicle 105, or at another distance. Device 100 may also be useful in backing into parking spots since as vehicle 105 approaches a barrier at the end of a parking spot, projected display 110 will slowly inch up the barrier. Once the driver of vehicle 105 is able to see projected display 110 in the rear view mirror, the driver will know to stop.

The projected display 110 preferably is one or more words, images, symbols, or other indications. The projected display 110 indicates to third-party drivers and observers that the vehicle is about to reverse. An embodiment of the invention includes projecting a word or set of words onto the ground and space behind and around a car. Other drivers or pedestrians in the area can view these words and be made aware of the reversing car. Examples of the projected word or words can include but are not limited to “BACKING UP” or “REVERSING.” These words can be formed by manipulating the housing of device 100 through which light is projected. For example, by etching, paining, engraving, shading, light blocking, applying a sticker, or otherwise altering the lens. The words can also be formed by a computer system or a laser system. If the words are formed using a computer system, the driver will preferably have a choice of different words to project from a predetermined set. The device may also be able to project shapes, symbols and images. The projected display 110 can also be projected by configuring a series of light bulbs into the shape of projected display 110.

For example, device 100 may be in communication with an application (app) running on a remote cellphone, tablet, or other computer. The app may be able to receive information from device 100. For example, the app may receive GPS information, battery level information, light bulb information, tamper detection information, temperature information, and other information about device 100. Additionally, the app may be able to send information to device 100. For example, the device may be able to control the message device 100 outputs, the colors of the message, the timing of the message, if the message blinks, control any audible alerts associated with the message, and disable the device. Furthermore, in embodiments used by law enforcement, device 100 maybe integrated into the vehicles emergency alert system or have features unique to emergency vehicles. For example, device 100 may output a siren that mimics the vehicle's siren.

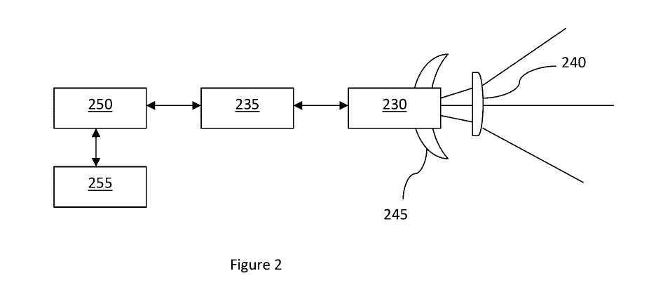

FIG. 2 depicts a schematic of device 100. Preferably, device 100 can project in one or more colors, including but not limited to orange, red, green, blue, white, yellow, and combinations thereof. The projected color is preferably neon. Preferably, the colors will be visible in both the daytime and at night. The visual cue 115 and projected display 110 is preferably provided by a lighting system 230. Lighting system 230 is preferably comprised of one or more high powered LED light bulbs. For example, the light bulbs can be High-power LEDs (HPLEDs), High-output LED (HO-LEDs) or other LEDs capable of producing between 90 and 1500 Lumens. However, lighting system 230 may employ incandescent bulbs, halogen bulbs, florescent bulbs, lasers, or other light emitting devices. Lighting system 230 may be powered by battery 235. Battery 235 is preferably a Lithium Ion rechargeable battery or another type of battery that may be charged by the vehicle, preferably via an auxiliary harness. Alternatively, the battery may serve as a backup power source and lighting system 230 may be coupled to the vehicle's electrical system. Lighting system 230 may project through a lens 240. Lens 240 can be concave, convex, or flat. Preferably, lens 240 is plastic, however lens 240 can be glass, crystal, or another material. Lens 240 is preferably a half-moon shaped device to allow for a spread of 180 degrees of light on a horizontal surface and 90 degrees of light on a vertical surface. Lighting system 230 may additionally have one or more mirrors 245. Mirrors 245 may be used to focus the light emitted by lighting system 230.

Preferably, device 100 is controlled by computer 250. Computer 250 is preferably an integrated circuit (i.e. a system on a chip (SoC)). The SoC integrates multiple components of a computer or other electronic system into a single chip. It may contain digital, analog, mixed-signal, and radio-frequency functions all on a single chip substrate. The SoC preferably incorporates a central processing unit (CPU), a graphics processing unit (GPU), and a system bus that couples various system components including the system memory, dynamic random access memory (RAM) and flash memory, to the SoC. The system bus may be one of several types of bus structures including a memory bus or memory controller, a peripheral bus, or a local bus using one of a variety of bus architectures. A basic input/output (BIOS) stored in flash memory or the like, may provide the basic routine that helps to transfer information between elements within device 100, such as during start-up. The drives and the associated computer readable media provide nonvolatile storage of computer readable instructions, data structures, program modules and other data for device 100. The basic components are known to those of skill in the art and appropriate variations are contemplated.

Although the exemplary environment described herein employs flash memory, it is appreciated by those skilled in the art that other types of computer readable media which can store data that are accessible by a computer, such as magnetic cassettes, hard drives, digital versatile disks, cartridges, random access memories (RAMs), read only memory (ROM), a cable or wireless signal containing a bit stream and the like, may also be used in the exemplary operating environment.

For clarity of explanation, the illustrative system embodiments are presented as comprising individual functional blocks. The functions these blocks represent may be provided through the use of either shared or dedicated hardware, including, but not limited to, hardware capable of executing software. For example, the functions of one or more processors presented in FIG. 2 may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) for storing software performing the operations discussed below, and random access memory (RAM) for storing results. Very large scale integration (VLSI) hardware embodiments, as well as custom VLSI circuitry in combination with a general purpose DSP circuit, may also be provided.

Device 100 may be adapted to project a single projected display 110 or multiple projected displays 110. In the embodiment where device 100 can project multiple projected displays 110, computer 250 may store the various options for projection and the vehicle's driver may be able to choose amongst the options. In another embodiment, the driver may be able to enter their own projected display 110. Interfacing with device 100 may be though hardware wired to the car, the car's internal computer system, an application on the driver's smart phone, or through another device. The driver may be able to have device 100 indicate an emergency. For example, the driver may be able to have device 100 blink or project an “EMERGENCY” or “HELP” projected display 110.

Preferably, device 100 is directly wired to the vehicle's control system. For, example, device 100 can be connected to the vehicle's reverse lights such that when the car is put into reverse, device 100 is activated as the reverse lights are activated. Another embodiment, device 100 is coupled to the gearshift of the vehicle. For example, device 100 can be wired, attached, or otherwise linked to the “reverse” gear position of the gearshift. This attachment will preferably enable the driver of a vehicle to turn the lighting system on and off by shifting in and out of reverse. In another embodiment, device 100 can also be wired, attached or linked to other features of the car, such as turn signaling, braking and other directional indicators within a vehicle.

Device 100 may further include a networking device 255. Networking device 255 is able to connect to, for example, the Internet, one or more Local Area Networks (“LANs”), one or more Metropolitan Area Networks (“MANs”), one or more Wide Area Networks (“WANs”), one or more Intranets, etc. Preferably networking device 255 is a Bluetooth device, other networking devices can be used. Networking device 255 may be capable of connecting to wireless Bluetooth devices (e.g. a keyboard or a mouse). The communication with the vehicle may also be wireless, such as through a Bluetooth system which can allow a computer within the car to interact wirelessly with the lighting system to turn it on and off or to switch its settings.

Device 100 is preferably attached to the rear of a vehicle, more preferably to the bumper of a vehicle. Device 100 can be connected above, below, or through a hole in the bumper. The invention can be attached with industrial double-sided tape, screws, bolts, welding, an integrated connector, hook and loop fasteners, or another fastening device. Device 100 may alternatively be coupled to another part of the vehicle. For example, the side mirrors, the under carriage, the trunk, or elsewhere on the vehicle. The device may also have a harness to connect to the auxiliary input of a vehicle, such as a trailer hitch light. Multiple devices 100 can be coupled to the car to project different information.

In another embodiment, device 100 include a speaker system that creates an auditory cue that coincides with the projection of the lighting system. The sounds is preferably an electronic recording or creation of the word that is being projected that the car omits. These electronically “spoken” words can include but are not limited to “backing up”, “caution”, “reverse” or any combination of these. The sound system can also be programmed to make a noise, such as beeping, music or another auditory cue to signal to pedestrians or others in the vicinity of the car of its direction.

Other embodiments and uses of the invention will be apparent to those skilled in the art from consideration of the specification and practice of the invention disclosed herein. All references cited herein, including all publications, U.S. and foreign patents and patent applications, are specifically and entirely incorporated by reference. It is intended that the specification and examples be considered exemplary only with the true scope and spirit of the invention indicated by the following claims. Furthermore, the term “comprising of” includes the terms “consisting of” and “consisting essentially of.”

1. A vehicle safety device, comprising:
an image projecting device; and
a vehicle communication device adapted to receive commands for the image projecting device;
wherein the image projecting device is adapted to project visible safety information.

2. The vehicle safety device of claim 1, wherein the image projecting device is an LED.

3. The vehicle safety device of claim 1, further comprising a computer coupled to the image projecting device, wherein the computer stores a plurality of projectable images and directs which of the plurality of projectable images the image projecting device is to project.

4. The vehicle safety device of claim 3, wherein the projectable images are at least one of words, icons, graphics, pictures, symbols, and combinations thereof.

5. The vehicle safety device of claim 3, wherein a choice of the plurality of projectable images is obtained through the vehicle communication device.

6. The vehicle safety device of claim 1, wherein the vehicle communication device is adapted to communicate with a vehicle's onboard computer, a portable personal communication device, or to receive signals from mechanical changes in the vehicle.

7. The vehicle safety device of claim 1, wherein the vehicle safety device alerts people in the vicinity of a vehicle that the vehicle is in reverse.

8. The vehicle safety device of claim 7, wherein the vehicle safety device is adapted to be mounted on a rear bumper of a vehicle.

9. The vehicle safety device of claim 7, wherein the vehicle safety device is adapted to projects the visible information onto a ground surface behind a vehicle.

10. The vehicle safety device of claim 7, wherein the vehicle safety device is adapted to be coupled to the vehicle's reverse indicators and activates when the reverse indicators activate.

11. The vehicle safety device of claim 1, wherein the projected visible information is surrounded by a beam of light.

12. The vehicle safety device of claim 11, wherein the beam of light projects at least 45° vertically and 90° horizontally from the image projecting device.

13. The vehicle safety device of claim 1, wherein the device is controlled by a remote computer application.

14. A vehicle safety system, comprising:
an image projecting device;
a mount coupling the image projecting device to a vehicle; and
a vehicle communication device adapted to facilitate communication between the image projecting device and the vehicle;
wherein the image projecting device is adapted to project visible information from the vehicle.

15. The vehicle safety system of claim 14, wherein the image projecting device is an LED.

16. The vehicle safety system of claim 14, further comprising a computer coupled to the image projecting device, wherein the computer stores a plurality of projectable images and directs which of the plurality of projectable images the image projecting device is to project.

17. The vehicle safety system of claim 16, wherein the projectable images are at least one of words, icons, graphics, pictures, symbols, and combinations thereof.

18. The vehicle safety system of claim 16, wherein a choice of the plurality of projectable images is obtained through the vehicle communication device.

19. The vehicle safety system of claim 14, wherein the vehicle communication device is adapted to communicate with the vehicle's onboard computer, a portable personal communication device, or to receive signals from mechanical changes in the vehicle.

20. The vehicle safety system of claim 14, wherein the vehicle safety device alerts people in the vicinity of the vehicle that the vehicle is in reverse.

21. The vehicle safety system of claim 20, wherein the vehicle safety device is mounted on a rear bumper of the vehicle.

22. The vehicle safety system of claim 20, wherein the vehicle safety device projects the visible information onto a ground surface behind the vehicle.

23. The vehicle safety system of claim 20, wherein the vehicle safety device is coupled to the vehicle's reverse indicators and activates when the reverse indicators activate.

24. The vehicle safety system of claim 14, wherein the visible information is surrounded by a beam of light.

25. The vehicle safety system of claim 24, wherein the beam of light projects at least 45° vertically and 90° horizontally from the image projecting device.

26. The vehicle safety system of claim 14, wherein the vehicle safety device is controlled by a remote computer application.
